(19) United States
(12) Patent Application Publication
(10) Pub. No.: US 2006/0030206 A1
(43) Pub. Date: Feb. 9, 2006

(54) Connector for flexible printed circuit

(75) Inventors: Chi Zhang, Kunsan (CN); Ren-Chih Li, Tu-Chen (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/123,350

(22) Filed: May 5, 2005

(30) Foreign Application Priority Data
Aug. 6, 2004 (CN) 2004200785009

(51) Int. Cl. H01R 12/24

(52) U.S. Cl. 439/495

(57) ABSTRACT

An connector (100) for a flexible printed circuit (FPC) includes a stationary housing (1) defining a mounting face (15) for mounted on a printed circuit board (PCB) and having a tongue plate (12) substantially parallel to the mounting face and spaced from the mounting face; a movable housing (4) detachably assembled to the first housing with its bottom face (46) substantially on the mounting face of the first housing, and its upper face (44) opposite to the tongue plate to define a cavity therebetween for receiving the FPC (6); and terminals (2) arranged on the tongue plate and projecting to the cavity to engage conductors on the FPC.

### BACKGROUND OF THE INVENTION

1. Field of the invention

The present invention relates to an electrical connector, and more particularly to an electrical connector for a sheet-like connection member such as a flexible printed circuit or cable (FPC), a flexible flat cable (FFC) and so forth. All of these cables and circuit will be generally referred to as “FPC”. The instant invention relates to a contemporaneously filed application having the same title, the same applicants, the same assignee with the instant application.

2. Description of Related Art

U.S. Pat. No. 5,816,845 discloses a connector for a FPC comprising a stationary housing having a cavity with an insertion port through which the FPC is inserted into the cavity; metal terminals mounted on the housing and inserted into the cavity; and a slide housing displaceable relative to the housing between a completely-retained position and a provisionally-retained position. When the FPC is to be inserted into the cavity, the slide housing is displaced to the provisionally-retained position to be held in a stand-by position outwardly of the insertion port. After the FPC is inserted into the cavity, the slide housing is also inserted into the cavity to the completely-retained position, to hold the metal terminals in contact with the FPC. However, such a connector requires the stationary housing to provide a sufficient size of height to define a cavity to receive the FPC and the slide housing.

Thereby, to meet the ever-increasing requirement of minimization of electrical components, a connector with a lower profile for FPC is desired.

### SUMMARY OF THE INVENTION

An object of the present invention is to provide an electrical connector that is decreased in size of height for a FPC.

Accordingly, to achieve the above object, a connector of present invention includes a stationary housing defining a mounting face adapted for mounted on a printed circuit board (PCB) and having a tongue plate substantially parallel to the mounting face and spaced from the mounting face; a movable housing detachably assembled to the first housing with its under surface substantially on the mounting face to the first housing, and its upper surface opposite to the tongue plate to define a cavity therebetween for receiving the FPC; and terminals arranged on the tongue plate and projecting to the cavity to engage conductors on the FPC.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an exploded view of a connector of the present invention;

FIG. 2 is an exploded view of the connector of FIG. 1 but taken from reversed aspect;

FIG. 3 is an assembled view of the connector of the present invention after being mounted on a printed circuit board, showing a movable housing in a provisionally-retained position relative to a stationary housing of the connector and a FPC being aslant inserted into the connector;

FIG. 4 is an assembled view of the connector of the present invention after being mounted on a printed circuit board, showing the movable housing in a completely-retained position relative to the stationary housing of the connector, wherein the FPC has been urged to contact terminals in the stationary housing;

FIG. 5 is a cross-sectional view taken along line 5-5 of FIG. 3; and

FIG. 6 is a cross-sectional view taken along line 6-6 of FIG. 4.

### DETAILED DESCRIPTION OF THE INVENTION

Reference will now be made to the drawing figures to describe the present invention in detail.

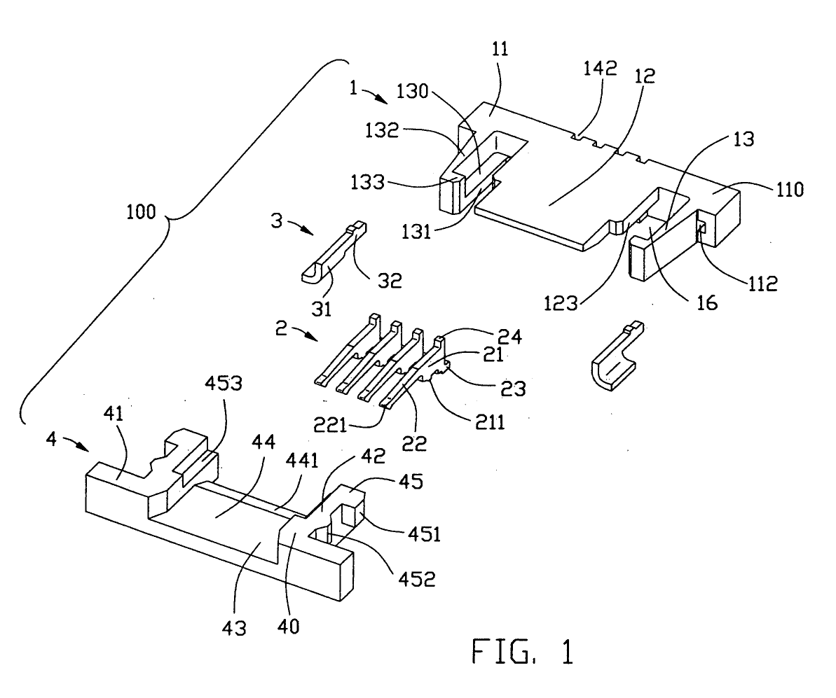

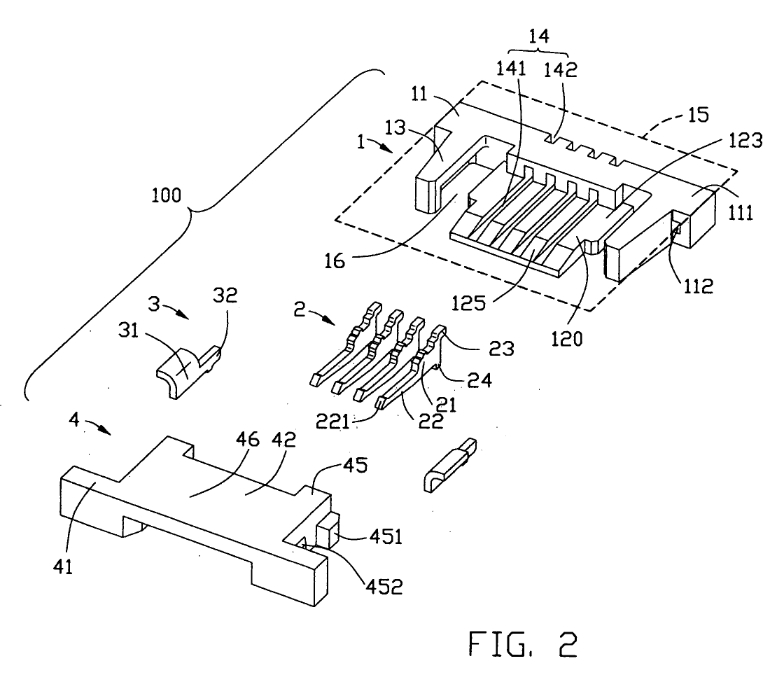

Referring to FIGS. 1 and 2, the connector 100 of the present invention comprises a stationary housing 1, terminals 2 to be arranged in the stationary housing 1, retainers 3, and a movable housing 4.

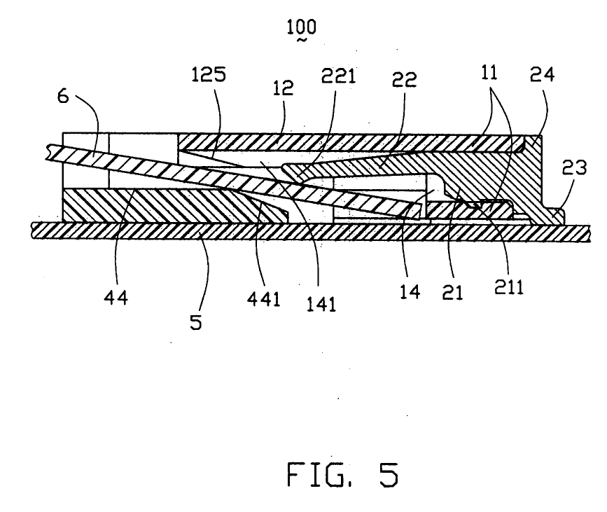

The stationary housing 1 has a lengthwise body portion 11, a tongue plate 12 breadthwise extending from the body portion 11 with its upper surface flush with an upper surface 110 of the body portion 11, and a pair of arms 13 oppositely beside the tongue plate 12 and extending from the body portion 11 with its upper surface and under surface respectively flush with the upper surface 110 and under surface 111 of the body portion 11. The under surface 111 of the body portion 11 defines a suppositional mounting face 15 for mounting on a printed circuit board (PCB). The tongue plate 12 has a first mating surface 120 facing the mounting face 15 with a vertical distance therebetween and defines a plurality of interior slots 141 on the first mating surface 120. Each interior slot 141 extends breadthwise throughout the body portion 11 to communicating a respective exterior slot 142 defined along a vertical direction, to form a unitary aperture 14 to receive the terminals 2. Additionally, the tongue plate 12 is trimmed to form a shortened edge 123. The first mating surface 120 inclines at that end remote from the body portion 11 to form a first slant 125, as best shown in FIG. 5. The arm 13 defines a recess 130 opening up and communicating with a space 16 between the arm 13 and the tongue plate 12.

The terminal 2 comprises a retain portion 21, an elastic arm 22 extending from one end of the retain portion 21, a solder tail 23 and a stop tail 24 respectively extending down and up from the other end of the retain portion 21. The elastic arm 22 has a contact portion 221 at the end thereof. The retain portion 21 has a retain leg 211 protruding downwards to be retained in the body portion 11 of the stationary housing 1.

Referring to FIG. 5 together, the terminal 2 is inserted into the aperture 14 from the exterior slot 142 with its elastic arm 22 received in the interior slot 141 and protruding towards the mounting face 15. The stop tail 24 is blocked in the exterior slot to stop the terminal 2 from moving ahead. The solder tail 23 is to be soldered to the PCB 5.

The retainers 3 each comprise an elbow 31 to be soldered to the PCB 5, and a leg 32 to be fixed into a hole 112 in the stationary housing 1 adjacent the outside of the arm 13 (shown in FIG. 1). Thus the retainers 3 retain stationary housing 1 to the PCB 5 to prevent the tongue plate 12 thereof from turning up during insertion of a FPC or the movable housing 4.

The movable housing 4 being of a “T” shape comprises a lengthwise body portion 41 and a mating portion 42 perpendicularly extending from the body portion 41, and is cut from an upper surface 40 thereof to define a passage 43 therein extending along a breadthwise direction throughout the body portion 41 and the mating portion 42. That bottom surface 44 of the passage 43 functions as a second mating surface and sidewalls 45 of the passage 43 function as slide legs. The second mating surface 44 declines at that end remote from the body portion 41 to form a second slant 441. Each slide leg 45 has a first slide block 451 and a second slide block 452 spaced protruding from its outer side, and defines a notch 453 by its inner side to engage the shortened edge 123 while the slide leg 45 is sliding into the space 16 of the stationary housing 1.

The movable housing 4 is assembled to the stationary housing 1 with an under surface 46 thereof sliding along the mounting face 15, the slide blocks 451,452 thereof being forced into the recess 130 in succession, and the notch 453 thereof fittingly engaging the shortened edge 123. Thus the slide blocks 451,452 are hold in the recess 130 by a bottom flange 131 thereof, to prevent the movable housing 4 from dropping down. The engagement of the notch 453 and the shortened edge 123 stops the movable housing 4 from moving up, thereby to keep a space between first mating surface 120 and the second mating surface 44 to form a cavity for receive the FPC. Otherwise, as the slide blocks 451,452 are hold in the recess 130, and are stopped from sidewalking by a side flange 132 thereof and from withdrawing by an end flange 133 thereof, the slide leg 42 therefore is retained in the space 16.

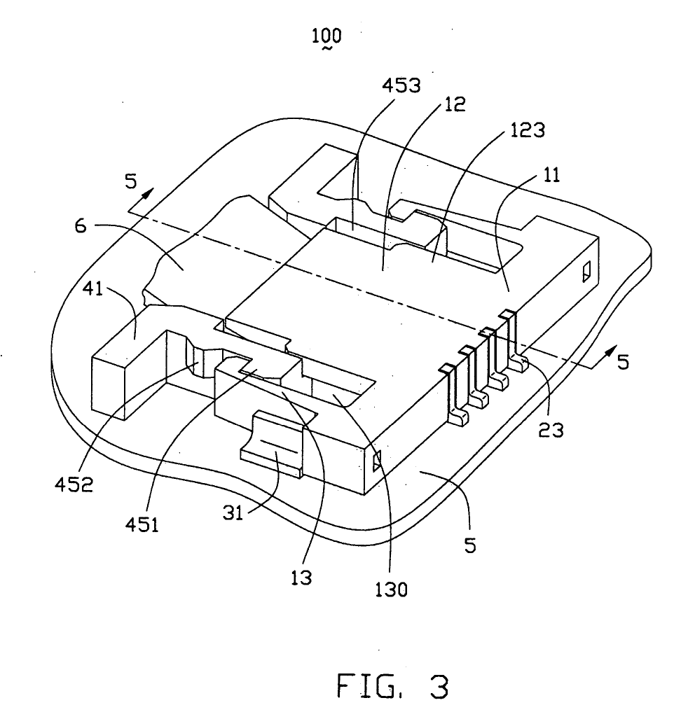

FIGS. 3 to 6 show the connector 100 being assembled and mounted on the PCB 5. Wherein the PCB 5 functions as a bottom wall of the stationary housing 1 to form a room together with the tongue plate 12 for receiving the FPC 6 and the movable housing 4. Thus a height size of the bottom wall is saved on the stationary housing 1. That decreases the whole height of the stationary housing 1.

As shown in FIGS. 3 and 5, when the first slide block 451 is forced into the recess 451 but the second slide block 452 is still left out, the movable housing 4 is located in a provisionally-retained position relative to the stationary housing 1. At this time, the second slant 441 of the second mating surface 44 is brought into being parallel to the first slant 125 of the first mating surface 120 to form a slantwise insertion-port for guiding a FPC 6 to enter into the cavity between the first mating surface 120 and the second mating surface 44. Thus the FPC 6 is aslant inserted through the insertion-port with a zero insertion force. As a result of the insertion of the movable housing 4 or the FPC 6, the tongue plate 12 of the stationary housing 1 would be turned up if the stationary housing 1 is attached to the PCB 5 only by the terminals 2 therein being soldered to the PCB 5. However, the existence of the retainers 3 further retains stationary housing 1 to the PCB 5 against turning up of the tongue plate 12.

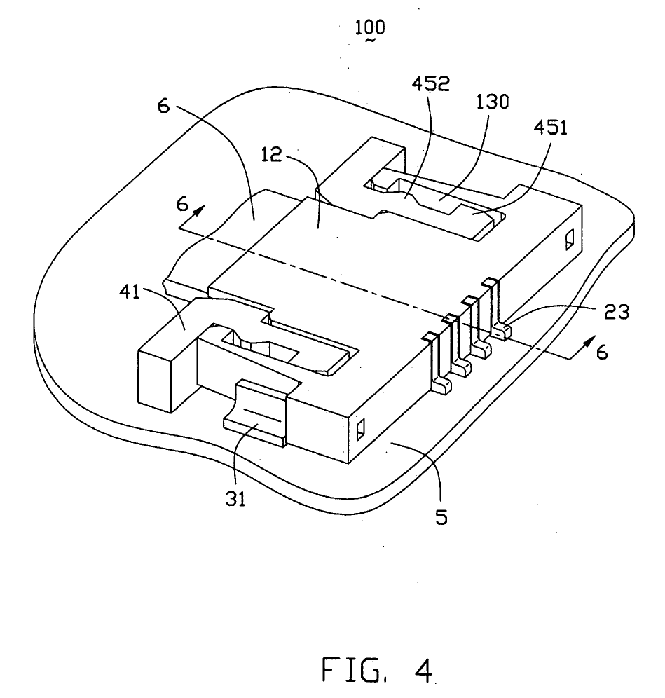

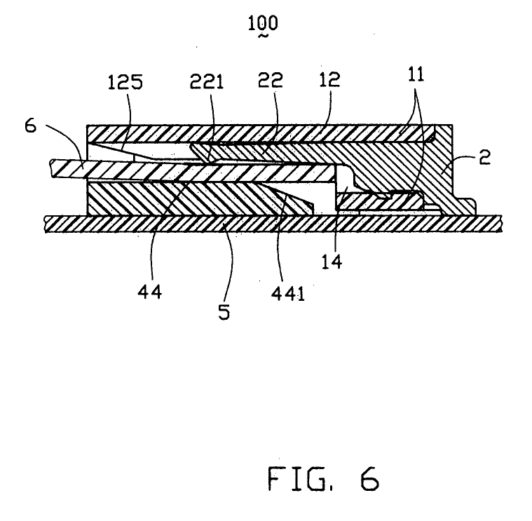

After the FPC 6 is inserted into the cavity, the movable housing 4 is further inserted towards the stationary housing 1, and the second slide block 452 is also forced into the recess 130. Now the movable housing 4 is in a completely-retained position, as shown in FIGS. 4 and 6. The second mating surface 44 of the advancing movable housing 4 urges the FPC 6 to rotate from the slanting state to a flat state to tightly contact the contact portions 221 of the terminals 2. That ensures electrical connection between conductors of the FPC 6 and the terminals 2.

Therefore, by such a design, an electrical connector with a lower profile for FPC is provided. However, the disclosure is illustrative only, changes may be made in detail, especially in matter of shape, size, and arrangement of parts within the principles of the invention.

1. A connector for a flexible printed circuit (FPC) comprising:
a first housing defining a mounting face adapted for being mounted on a printed circuit board (PCB) and having a tongue plate spaced from the mounting face;
a second housing movably assembled to the first housing and defining an under surface coplanar with the mounting face of the first housing and an upper surface facing the tongue plate to define a cavity therebetween for receiving the FPC; and
terminals arranged on the tongue plate and projecting into the cavity to engage with the FPC.

2. The connector as described in claim 1, wherein the second housing is movable relative to the first housing between a provisionally-retained position adapted to receive the FPC into the cavity and a completely-retained position adapted to urge the FPC against the terminals to establish electrical connections therewith.

3. The connector as described in claim 2, wherein the first housing defines a first slant, and the second housing defines a second slant, the second slant being substantially parallel to the first slant to form an insertion port for guiding the FPC into the cavity when the second housing is in the provisionally-retained position relative to the first housing.

4. The connector as described in claim 1, wherein the first housing has a body portion defining the mounting face, and the tongue plate extends from the body portion and substantially parallels to the mounting face.

5. The connector as described in claim 4, wherein the first housing has a pair of arms extending from the body portion and disposed beside the tongue plate to define a retention space between each arm and the tongue plate to fix the second housing.

6. The connector as described in claim 5, wherein the second housing has a slide leg configured to slide into the retention space to be locked therein.

7. The connector as described in claim 6, wherein the arm of the first connector defines a recess opening upwards and communicating with the retention space, and the slide leg of the second connector has a bulge portion formed to forcibly slide into the recess to be held therein.

8. The connector as described in claim 6, wherein the slide leg defines a slide notch to fit a lateral edge of the tongue plate during the slide leg sliding into the retain space.

9. The connector as described in claim 7, wherein the bulge portion comprises two spaced tubers, the second housing being in a provisionally-retained position when only the first tuber is slid into the recess and the second housing being in a completely-retained position when the second tuber is slid into the recess as well.

10. The connector as described in claim 1, further comprising a retainer adapted to fasten the first housing to the PCB, and comprising one end fixed to the first housing and another end soldered to the PCB.

11. A connector assembly comprising:
a printed circuit board (PCB);
a first housing having a body portion mounted on the PCB, and a tongue plate projecting from the body portion and facing with and spaced from the PCB, the tongue plate having a plurality of terminals arranged thereon; and
a second housing movably assembled to the first housing and defining an under surface adjacent to the PCB and an upper surface facing the tongue plate to define a cavity therebetween for receiving the FPC, the second housing being movable relative to the first housing between a provisionally-retained position to let the FPC to enter the cavity and a completely-retained position to urge the FPC against the terminals to establish electrical connections therewith.

12. An electrical connector assembly comprising:
a printed circuit board;
a stationary housing seated upon the printed circuit board and defining a mating tongue with a plurality of contacts therein, a pair of arms located by two sides of the mating tongue with a pair of recesses spaced from the mating tongue, respectively, each of said pair of recesses communicating with an exterior in both upward and forward directions; and
a moveable housing defining a mating portion with a pair of slide legs by two sides thereof, said moveable housing defines opposite front and rear positions with regard to the stationary housing; wherein
when assembled, the slide legs of the moveable housing are received in the corresponding recesses, respectively, and movable between opposite front and rear positions in a horizontal direction; wherein
the stationary housing defines nothing located above or below the mating tongue in a vertical direction.

13. The electrical connector assembly as claimed in claim 12, wherein the mating tongue is located above the mating portion, when assembled.

14. The electrical connector assembly as claimed in claim 12, wherein each of the arms defines an enlarged head to prevent the corresponding slide leg from further forwardly moving away from the corresponding recess.

15. The electrical connector assembly as claimed in claim 12, wherein internegagement occurs between the stationary housing and the moveable housing in said vertical direction, perpendicular to said horizontal direction, for retaining the moveable housing to the stationary housing in said vertical direction when said slide leg is horizontally moveably received in the corresponding recess between said first and second positions.

16. The electrical connector assembly as claimed in claim 13, wherein nothing, except said mating portion, is located between the mating tongue and the printed circuit board in said vertical direction.

17. The electrical connector assembly as claimed in claim 12, wherein the slide legs are upwardly exposed to the exterior.
